(19) United States
(12) Patent Application Publication
(10) Pub. No.: US 2012/0059883 A1
(43) Pub. Date: Mar. 8, 2012

(54) SYSTEMS AND METHODS FOR SELECTING AND/OR COMMUNICATING WEB CONTENT

(76) Inventor: Leon YOHAI-GIOCHAIS, Great Falls, VA (US)

(21) Appl. No.: 12/877,316

(22) Filed: Sep. 8, 2010

(51) Int. Cl. G06F 15/16; G06F 3/01

(52) U.S. Cl. 709/206; 715/747; 709/217

(57) ABSTRACT

The present invention provides systems and methods for selecting and/or communicating web content. Systems and methods are disclosed for rendering object(s) in web pages movable by a user of a client device. The object(s) may further be selected for communication to one or more other device(s) and/or location(s). For example, the one or more other device(s) may include mobile devices such as cell phones, personal digital assistants, pocket PCs, laptops, etc. In addition, the one or more other location(s) may correspond to a storage location in memory, a weblog, etc. The invention also discloses inserting a customizable window in the displayed web page for receiving selected object(s) and/or other personal text or information. Methods for performing business over a computer are also disclosed which include displaying advertisements relevant to the selected object(s) in the customizable window.

### BACKGROUND OF THE INVENTION

1. Field of the Invention

The present invention relates to systems and methods for communicating content over the Internet. More specifically, the invention relates to systems and methods for providing a variety of content to mobile devices.

2. Description of Related Art

The World Wide Web, or “web”, is comprised of numerous, vastly distributed repositories of information (typically residing on servers) and is used to communicate a variety of content over the Internet. Clients, through their browsers, are able to obtain content in the form of “web pages” stored on servers. Web pages may be accessed using an HTTP request that includes the location of the page as identified by the Uniform Resource Indicator (URI; also referred to as a Uniform Resource Locator or URL). In response, the server containing the desired web page sends the requested content to the client. However, before the web page can be displayed to a user, a browser is needed to interpret and display the content received from the server. The Hyptertext Markup Language (HTML) is the language predominately used for creating web pages and specifying their appearance to the browser.

Web pages are able to display and communicate a wide variety of content such, as images, music, games, text, etc. Various forms of content (such as images, graphics, etc.) can be valuable for communicating thoughts or ideas in an efficient and easily recognizable manner. In addition, images and music are not as easily hindered by differences in human languages and can therefore help to improve communication or to provide support for ideas. Thus, web pages are a useful tool for communicating many different ideas and thoughts quickly and efficiently.

Dynamic web pages further increase the capabilities of web pages by enabling enhanced user interaction. Dynamic web pages follow certain logical structures and are able to detect various user events such as: onClick, onMouseover, onSelect, onSubmit, etc. For example, a user click on a button element may correspond to an “onclick” event. The “onclick” event, then calls a particular function to be executed. Thus one feature of dynamic web pages is improved user interaction capabilities.

Along with the web, mobile devices such as cell phones, personal digital assistants (PDAs), pocket PCs, and the like have increased in popularity for communication of information as well as social interaction. For example, interaction through text messages, e-mails, photos, etc. allows users to communicate thoughts and ideas in improved and more efficient ways. Recent years have further demonstrated the proliferation of premium content services for mobile devices (such as ringtones, wallpaper, games, etc.) as a result of the ongoing desire for enhanced functionality.

Most cell phones are equipped with a “standard” set of ringtones, games, images, etc. However, some online companies allow users to download specialty ringtones, wallpaper, games, etc. on a fee-per-download basis, for example. FIG. 1 illustrates an example where premium content may be offered for download to a user's mobile phone by a value added service provider. Typically, the user is able to browse the provider's web site and choose ringtones, images, games, etc. from a predefined collection for download to their mobile phone. If the content the user is looking for is not available in the database, the user may request the content, but might have to wait a certain period of time before it becomes available. Once desired content is available and selected for download, the user might then be required to submit their mobile phone number, brand, and model (to ensure the content is compatible with his phone). Typically, the content must be delivered to the user's phone through the mobile network operator. This requires the value added service provider to forward the content to the mobile network operator, who then distributes the content to the user, typically in exchange for a share of the revenue, or for a transport fee.

Most mobile devices such as mobile phones, personal digital assistants (PDAs), and the like also have a certain amount of web browsing functionality. For example, Wireless Application Protocol (WAP)-enabled phones can access web content using a “scaled-down” browser built into the phone. However, oftentimes this functionality remains limited because of inherent tradeoffs that must be made in the design. For example, one challenge is how to balance web browsing capabilities with the size of the device. In other words, as the size of e.g., mobile phones decreases, it becomes more difficult to display web browsing options or key in search terms. In addition, although faster processing speeds may be desirable for browsing, this may also require a tradeoff in terms of battery life. For example, mobile phones with faster processing speeds may need to be charged more frequently, introducing other inconveniences to the user.

Mobile devices are also able to receive content from other network devices. For example, U.S. patent application publication number 2006/0015649 to Zutaut et al. discloses a system and method for distributing media content from a first network device to a mobile device that converts the media content from the first format to a format recognizable by the mobile device. The first format may be converted to the second format e.g., by obtaining configuration information about the mobile device. Furthermore, U.S. Pat. No. 7,113,801 to Back et al. discloses sending a message containing a URL from a service provider to a mobile terminal of a user, where the mobile user may access content by selecting the URL. In addition, U.S. Pat. No. 7,139,372 to Chakravorty addresses authorized distribution of content to mobile devices by the mobile service provider through an SMS message containing a link to content.

One main drawback of above-described technologies is that distributed content is limited to pre-selected ringtones, wallpaper, games, etc. Thus, if a user is unable to find certain content, he must wait until it becomes available. Another key drawback to the above-mentioned technologies is that there is little user interaction regarding the content available to be selected. Thus, if users need certain web content to communicate ideas to mobile devices, they are currently limited in how quickly and easily they are able to convey this kind of information. Yet another drawback of the above-described technologies is that content available for download must typically be distributed through the mobile network operator, thereby hindering flexibility, ease of access, and profit.

As a result, there remains a need to allow user interaction and selection of a wider variety of content from web pages, etc. It would also be desirable to select content from a web page for communication to another device and/or location without the need for refreshing or reloading the web page. There also remains a need to provide a wider variety of content to mobile devices. It would also be desirable to use some of the enhanced functionalities afforded e.g., by dynamic web pages to provide extra services to mobile devices. It would further be desirable to provide a variety of content to mobile devices without the needing to be distributed through the mobile network operator or service provider.

### SUMMARY OF THE INVENTION

The present invention provides solutions to the above described drawbacks, and fulfils needs in the art. The invention provides systems and methods for allowing users to select a wider variety of content from the web for communication to one or more devices and/or locations. In addition, methods for performing business over computers are also disclosed.

As used herein, “a” or “an” means one or more, “content” refers to one or more objects or multimedia objects, and “object” refers to an electronic file that may comprise one or more documents, images, sounds, music, games, graphics, data, text, etc. As used herein, the term “display” refers to any action that results in an object being rendered in a form that is detectable by a human sense. Thus, displaying of an image results in depiction of the image in a manner that allows a human to see it; displaying a sound or music results in a user being able to hear it, etc.

According to one aspect, the invention provides a system for enabling a user to select content to be communicated from a location on the Internet to a mobile device. In general, the system can include at least two devices comprising or comprising a network, and software that enables the two devices to communicate and cause an action to be taken that enables one of the devices or a third device to capture an object and display it, where the object can be an object that is either intended to be capturable and movable or not. For example, the system may comprise: a network comprising two or more computing devices connected to each other by way of the network; and software that allows an object on a first device to be identified and transmitted to a second device, wherein the object on the first device is not necessarily presented on that device as a movable or removable object. That is, the system enables a user to capture an object rendered by a first device and transmit it to a second device, regardless of whether the first device renders the object as a movable object. For example, a user of the system may select an image from a web site and have the image transmitted to a mobile phone, whether or not the entity owning, operating, or providing the web site renders the image as a movable object. In embodiments, selection of the object is performed through use of a third device. In embodiments, the second device is a client device configured to receive content over the network, where the client device includes: a display, an input device, and a browser that presents the content on the display. In embodiments, the system comprises a server connected to the network, the server maintaining a portal configured to cause content to be directed through the server over the network before being received by the client. In embodiments, the portal further interacts with one or more application(s) at the server and/or client device, and often the application(s) are configured to render portions of the received content movable by the user through the browser display and input device.

According to another aspect, the invention provides a method for allowing a user of a client device to select one or more objects rendered by a first device to be communicated to one or more second devices and/or locations, where the objects to be communicated are not necessarily objects that are rendered by the first device in a manner that allows them to be captured and/or moved. In essence, the method provides the ability to render all objects by the first device movable, and allows users to capture the objects and move them to other devices. In general, the method comprises: accessing content rendered by a first device, such as by opening a web page rendered by a first device using a browser of a client device; selecting one or more objects to be communicated; moving the objects into a customizable window, which may be represented by an icon or graphic; and performing one or more user events to initiate delivery of the objects to one or more second devices and/or location(s). For example, the method may comprise accessing a web page on the Internet, selecting an object of interest by placing a cursor over the object, and dragging and dropping the object to an icon rendered on top of the web page (by the system of the invention), wherein dragging and dropping the object onto the icon causes the system of the invention to forward a link to one or more mobile phones. The users of the mobile phones may then access the link to download the object to one or more mobile phones.

According to yet another aspect, the invention provides a method for allowing one or more objects in a web page to be selected by the user of a client device and communicated to one or more second devices and/or locations. In general, the method comprises: identifying one or more objects displayed on the web page; rendering the identified objects selectable and/or movable by the user through an input device; providing a customizable window that is displayed in conjunction with the web page; detecting objects moved into the customizable window by the user; and detecting one or more user events to initiate delivery of the detected object(s) to the one or more second devices and/or locations.

According to a further aspect, the invention provides a method for performing business over a network using a computer. In general, the method comprises: performing all or part of the methods described above; displaying advertising in a customizable window, and charging a third party as a result of displaying the advertising. For example, the method may comprise: performing all or part of the methods described above; obtaining advertisements relevant to the detected object(s) from one or more third parties; displaying the advertisements in the customizable window; and charging one or more third parties a fee for displaying the advertisements. The fee may be charged to the advertiser according to any known Internet advertising model, or to any other third party.

According to another aspect, the invention provides computer programs (software) and/or hardware for performing method steps of the present invention. In general, the programs are written and implemented according to common computer technology, languages, etc. Further, in general, standard computer hardware, such as those used in Internet communication and mobile phones, are used. In embodiments, the computer programs and/or hardware may take the form of web applications and/or scripts performed at the client, server, and/or mobile devices. In embodiments, object(s) in a web page may be selected and moved without the need to refresh the browser display. In further embodiments, SMS, MMS, or e-mail messages may be used to send to send a link to the objects without the need to distribute the content through a mobile service operator.

### BRIEF DESCRIPTION OF THE DRAWINGS

FIG. 1 depicts an example of premium content available for download from the web using currently available technology.

FIG. 2 is an exemplary block diagram of a system according to an aspect of the present invention.

FIG. 3 is another exemplary block diagram of a system according to an aspect of the present invention.

FIG. 4 is an exemplary flowchart of method steps according to another aspect of the present invention.

FIGS. 5A-5H depict exemplary locker window “screens” displayed to a user of a client device.

FIGS. 6A-6C illustrate the locker window present on various browser displays of the client device.

FIG. 7 is an exemplary flowchart of method steps according to another aspect of the present invention.

FIGS. 8A-8C depict exemplary mobile device message “screens”.

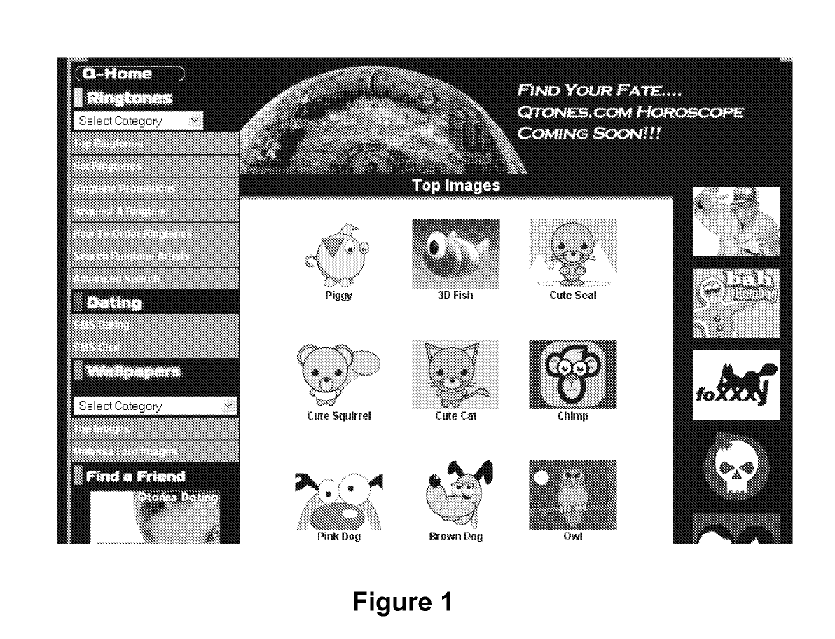

### DETAILED DESCRIPTION OF VARIOUS EMBODIMENTS OF THE INVENTION

Reference will now be made in detail to various exemplary embodiments of the invention. The following detailed description is provided to better illustrate certain details of aspects of the invention, and should not be interpreted as a limitation on the scope or content of the invention. It is to be understood that, unless otherwise noted, any suitable computer code, language, etc. may be used to achieve the actions described below, and one of skill in writing computer code can readily create such code using the information provided herein.

Various embodiments of the invention relate to movement of objects accessible via the Internet. In general for these embodiments, the present invention describes systems and methods for allowing users to select a wider variety of content from the web for communication to one or more devices and/or locations. In addition, the method steps may be implemented by way of computer hardware and/or programs including web applications and/or scripts. Methods for performing business over computers are also disclosed.

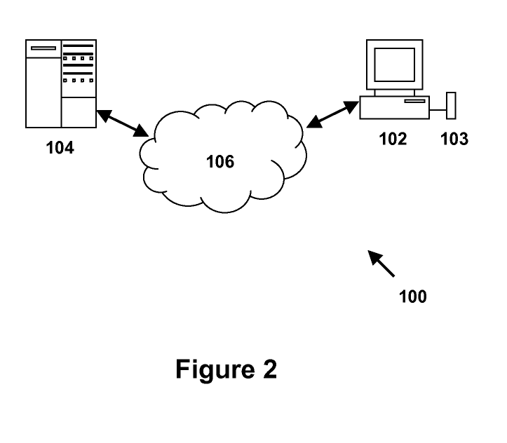

FIG. 2 illustrates a system for communicating objects over a communication network 106. As shown, the system includes a client device 102 and a server 104, in communication with one another over the communication network 106. Although it is understood that the invention may involve one or more client devices 102 and servers 104, for simplicity purposes, only one of each is shown in the figure. The client device 102 may be e.g., a PC including an operating system such as Microsoft Windows, Windows Vista, MAC OS, LINUX, etc., and a browser such as Internet Explorer, Netscape, Mozilla, etc. The client device 102 preferably includes an input device 103, such as a mouse, pointing device, touch pad, keyboard, touch-screen display, and the like for interacting with the browser. The client device 102 also comprises one or more processors, memory, a monitor, etc. The server 104 may comprise e.g., one or more processors, memory, a database, etc. In addition, memory may include any known media for long-term or short-term storage of computer information including: RAM, ROM, optical disk, magneto-optical disk, magnetic tape, or the like. It is also appreciated that the network 106 may comprise a combination of wired, wireless, and optical connections, etc.

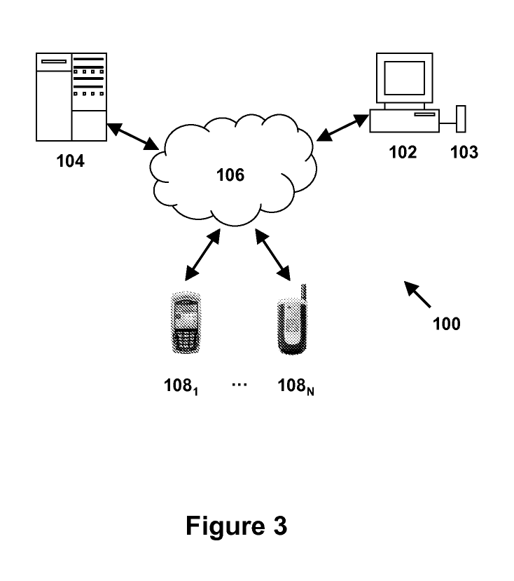

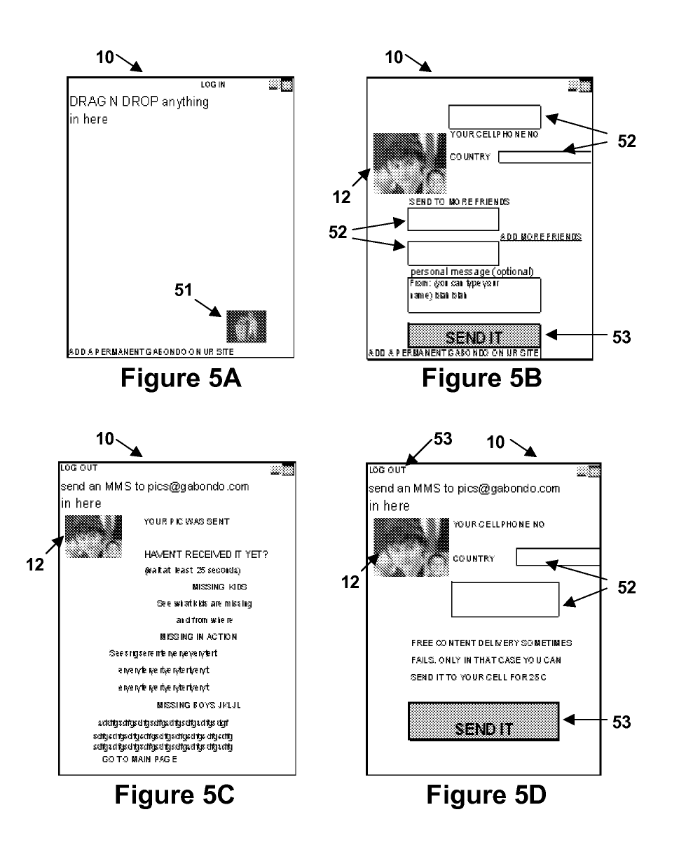

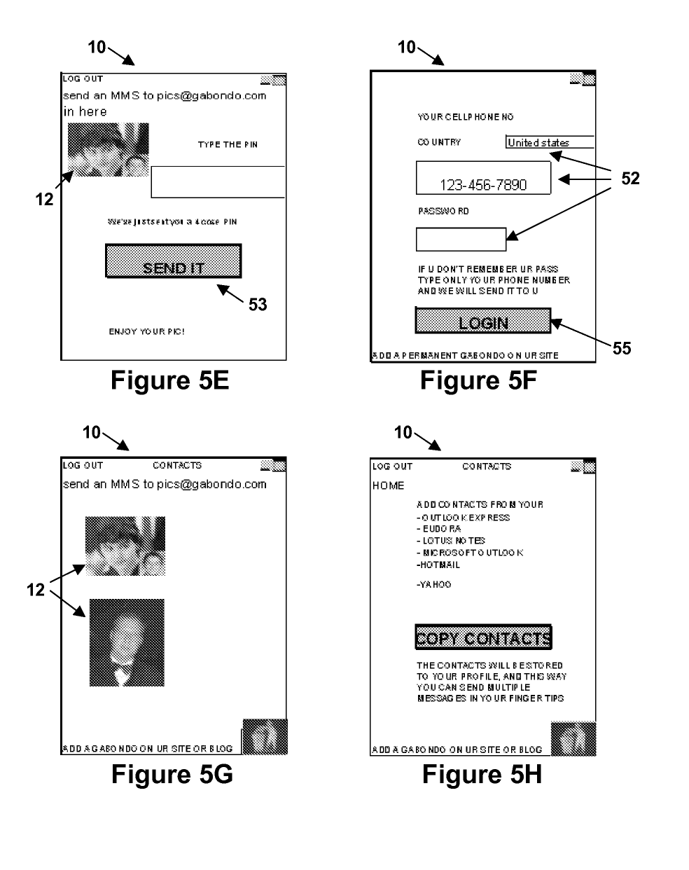

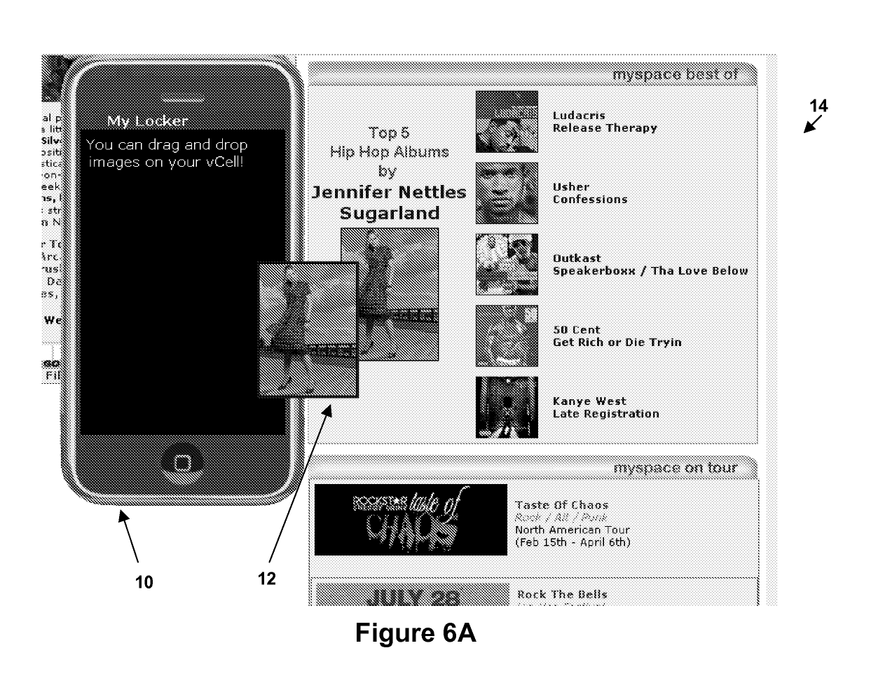

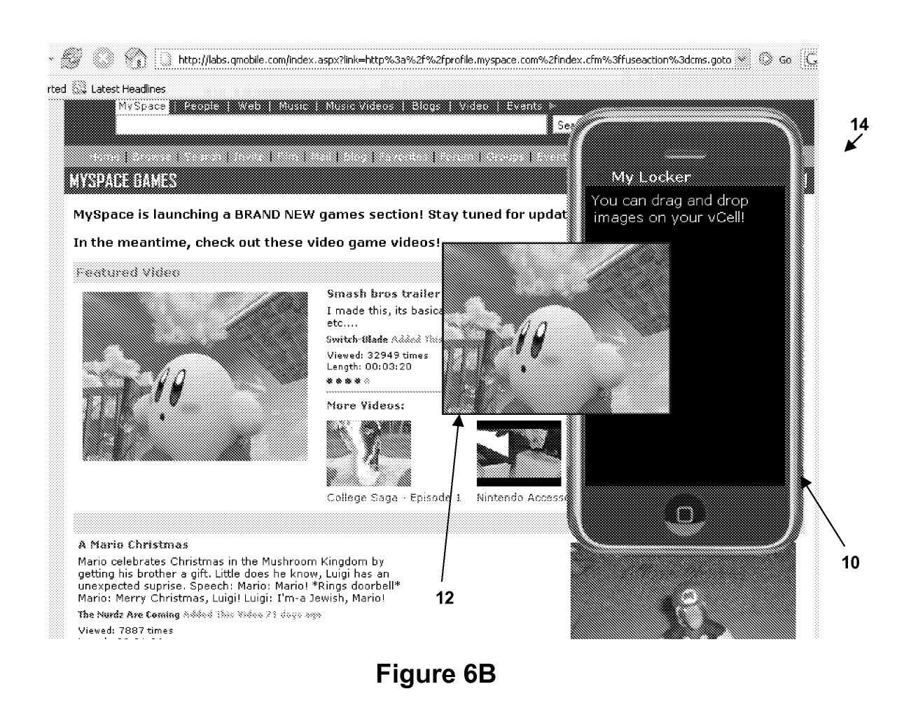

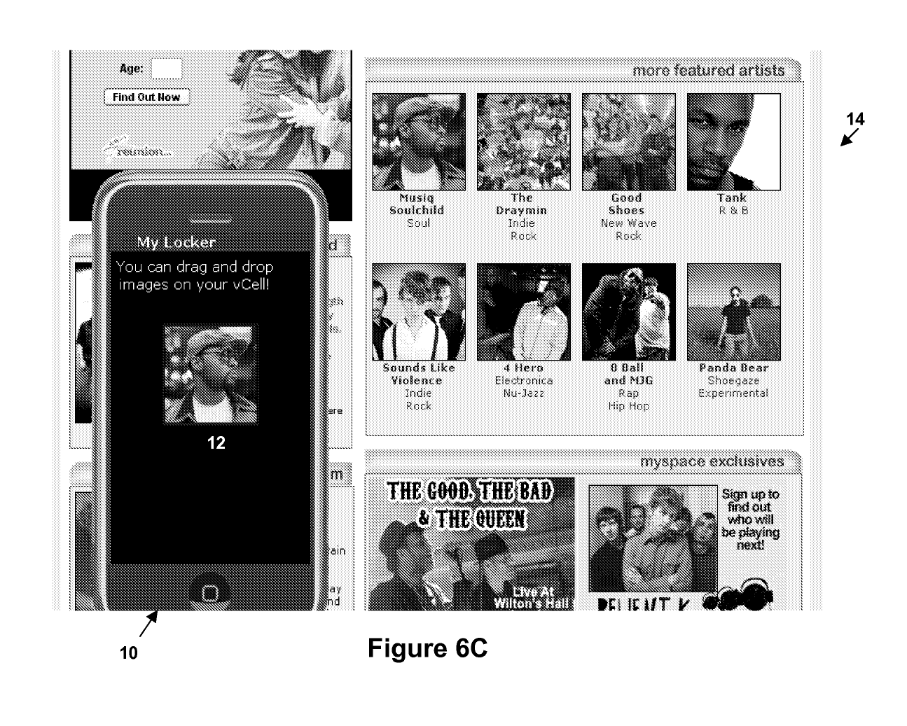

FIG. 3 is similar to FIG. 2 described above, and further illustrates one or more mobile devices 108₁-108_{N} for receiving object(s) 12 (see FIGS. 5 and 6) communicated from the client device 102. The mobile device(s) 108₁-108_{N} may each comprise one or more processors, memory, a keypad, display, power source, transmitter, receiver, etc. The mobile device(s) 108₁-108_{N} may communicate with the network via a base station, mobile switching station, or other conventional means. In embodiments, an SMS, MMS, e-mail, etc. message is sent from the server 104 to the mobile device(s) 108₁-108_{N} (e.g., in the form of a link) pointing to the location of the object(s) 12.

Regarding FIGS. 2 and 3, software applications may reside in memory of the client device, server, and/or mobile device(s) and are preferably configured to perform the method steps of the present invention. For example, portions of the application(s) may be executed by the client device, server, and/or mobile devices. In other examples, the application(s) may be executed on a single device, such as the client device. In addition, method steps could be performed through a browser on the client device and while processing is performed on the client device or server. At least one application may include a user interface that provides increased interactivity to a user so that a variety of objects can be selected from web pages.

In embodiments, the server 104 application(s) are based on the NET 1.1 framework by Microsoft and use e.g., the MS SQL Server 2000 as a database. In addition, application(s) residing on the server may include asp.net web application(s) written e.g., in C#. The server application(s) may be configured to perform the following functions: inserting or implanting a locker window 10 into web pages as they are opened by the user, and ensuring that the locker window 10 remains somewhere on the screen as the user surfs through different web pages; enabling storing and managing of stored object(s) 12; and enabling or initiating sending of selected content (or links) to mobile devices 108, email addresses, etc. The server application may also include the following logical levels: an “implantator” that implants the locker window 10 into web pages e.g., dynamically, as web pages are opened by the user; a “links transformator” that may transform links in web pages in order to enable browsing with the locker window 10 inserted into the web pages (e.g., by changing relative URIs, such as images' SRCs, to absolute, etc.); and a data access layer that implements data access functionality. Class libraries for the above levels or functions may include: VCelllmplantator; VCellLinksTransformator; VCellTransformTools; vCellBase; vCellDal; and vCellData, etc.

Although the term “locker window” is used herein, it is understood that the window 10 may take any size (e.g., an icon, window), form, or shape. For example, the window 10 may be presented in the shape of a mobile or cell phone, a laptop, or any other device. Thus, the “look and feel” of the locker window 10 may vary depending upon the application or user group and is not meant to be limited by way of this disclosure.

The client device 102 may include a browser, such as Internet Explorer, Mozilla, Netscape, etc. In embodiments, applications or software executed on the client device 102 may include JavaScript code that performs the following functions: obtaining a collection of multimedia object(s) (e.g., images, music files, video files, etc.) in the web page; attaching listeners to each object; finding the absolute position(s) of the object(s); positioning a copy of each object on its absolute position; causing the copy to move with mouse moves; turning on various forms (or “screens”) in the locker window 10; and copying the selected object to the image container in the locker window 10. In embodiments, the above listeners may be activated e.g., every time the user positions a cursor over each object such that the handler of the event goes through the ancestors of the object which fired the event, summing their relative positions to obtain the absolute position (in this, or other processes, the DOM model may be used). Then an object with the same SRC as the one that fired the event may be positioned on the absolute position, thus becoming its copy. The copy may then be moved according to mouse moves. In addition, if the user releases the mouse button over the locker window 10, a JavaScript function may then be called that turns on the form or “screen” for sending the image, and copies the image to the image container in the locker window 10. After the user initiates sending of the content, other e.g, AJAX scripts may be invoked to pack the user data and send it to the server 104. In this way, the server 104 may ask the client 102 for the contents of the locker window 10 without disturbing the rest of the web page.

For purposes of illustration, forwarding of content to mobile phones will now be addressed by way of example, however it is understood that the invention is not so limited and may include other mobile devices such as personal digital assistants, pocket PCs, laptops, and the like. Moreover, it is understood that objects may also be sent to a logical location such as a location in memory of the client device 102, a location in memory of the on the server 104, a web-log, etc.

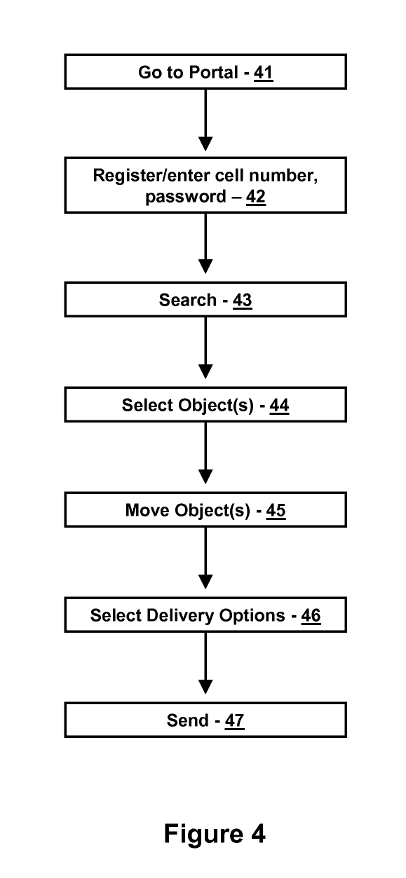

FIG. 4 shows a flow diagram that describes exemplary method steps that take place at the client device 102. It is appreciated that the following steps need not be performed in the order listed, and that other steps may be performed in between. The user opens a browser on the client device 102. In step 41, the user visits the portal web site maintained by the server 104. In order to use the services of the portal, the user may be required to register (if it is the first time), or login using a mobile phone number and password (see step 42). The user may then be provided 43 with a search tool to search or browse web content through the portal. It is noted that the search tool may be a proprietary search tool, or may be powered by a conventional search engine such as Google, Yahoo, etc. Upon viewing the search results, the user may select a desired web page to open. The client and/or server web application(s) cause the user's browser to display a page where the object(s) in the original web page have been rendered movable (as described in further detail below). Additionally, a customizable locker window 10 (see FIGS. 5 and 6) is preferably provided somewhere on the web page. Selected objects 12 may then be dragged into the window 10 to initiate delivery to another location (e.g., to a mobile phone, weblog, desktop, etc.). According to embodiments, the user is able to: select 44 one or more objects 12 on the web page (such as images, audio files, video files, etc.) and move 45 the selected object(s) 12 into the locker window 10. In addition, the user may be able to manipulate the locker window 10 such that it can be: maximized or minimized, floating and independent of the host site, etc.

In embodiments, movement 45 of the selected object(s) 12 into the window 10 provides an indication of what object(s) 12 are to be sent. The user may have the option to manipulate the object(s) 12 in the locker window 10 (such as modify, delete, etc.) as well as to add personal text, messages, etc. Other delivery options 46, such as additional delivery destinations (e.g., friend phone numbers, emails, etc.), send now, send later, etc. may also be selected. Once all of the desired options have been selected, the user may click a button, or the like, to send 47 (e.g., a link to) the object(s) 12. Alternatively, it is appreciated that an automatic delivery process may be provided, where the action of moving or dragging 45 the object(s) 12 into the window 10 initiates the send 47 process.

FIGS. 5A-5H are representative of various user interface “screens” that may be displayed in the locker window 10 with the above described method steps. These figures are for illustration purposes only, and it is understood that not all of these screens may necessarily be encountered, or encountered in the same order or format. Additionally, other user options may be available than those shown. FIG. 5A, for example, illustrates an embodiment where the user visits the web portal for the first time. A locker window 10 appears somewhere on the browser screen with a message such as “Drag N Drop anything in here”. The user may then choose to select an object 12 and drag it into the window 10. The user may also have the option to delete object(s) 12 later (for example by placing on the trash can icon 51 or using a pull down menu) if he changes his mind. In embodiments, if the user leaves his mouse on an object 12 for more than a few seconds, a message such as “Drag N drop this picture”, may be displayed over the object 12 and the locker window 10 may appear from minimized status. In other embodiments, if the user clicks on an object 12 or on the message, the object 12 may automatically go to the window 10 (without any need for dragging it).

After one or more object(s) 12 have been placed into the window 10, form fields 52 may then appear requesting user information such as mobile phone number for delivery, country, third party (e.g., friend, associate) addresses or phone numbers, personal messages, advertisements, etc. as shown in FIG. 5B. Multiple third party addresses may be entered, for example, by separating with commas, semicolons, or other conventional means. (As shown in FIG. 5H, profile contacts may be easily added, for example, from Outlook Express, Lotus Notes, Hotmail, Yahoo, etc.) If this is the user's first time visiting the site, these forms 52 will appear blank. Optionally, a password may also be requested. If the user does not have a password, or forgets his password, he may request that it be sent to his mobile phone 108. Once the user has entered all of the information, he may click the send button 53, or the like, to initiate sending of the object(s) 12 to the designated addresses or locations. Once the send button 53 has been selected, a status message indicating that the object(s) 12 were sent may be displayed, as shown in FIG. 5C. In addition, other messages may be displayed such as further status messages, advertising information, news, etc.

When the message and link(s) are received on a mobile phone 108, the link(s) may be selected to download the object(s) 12. In embodiments, if the message is not received by the user's mobile phone 108 after several seconds, the message “Haven't received it yet?” may appear in the locker window 10. Upon clicking on this message, a screen may be displayed as shown, for example, in FIG. 5D. Some of the same form fields 52 such as mobile phone number and country may appear (which may be filled from previous entries). In embodiments, this screen may also display some “Terms and Conditions”, where the user may need to select “I agree” before selecting the send button 53. After clicking send, a request may be performed to the server such as: www.gabondo.com/send_pin.aspx?country=Arizona&cell_no=17033895261. A Send_pin script may also be used to create a pin and send it to the user's phone.

FIG. 5E shows where the user may enter the PIN he received on his mobile phone and then select the send button 53. As shown in the upper left portion of the figure, the user may also have the menu option to “log out” 54 if he chooses. Selecting “log out” 54 would take him to a window similar to FIG. 5F. As now shown in the “log in” screen of FIG. 5F, the mobile phone number and country fields 52 are preset based on the session data. Here, the user needs only to enter his password and select the “log in” button 55. If the user is not registered yet, or has forgotten his password, he can leave the password field blank and it will be sent to his phone 108. He may then receive a message in the locker window 10 to the effect: “We've just sent the password to your mobile phone. Please type it above to log in.” He may also receive a message on his mobile phone 108 such as: “Your account is created. Your password is . . . .” After the password has been entered and confirmed, the user's locker window 10 may be displayed as depicted in FIG. 5G.

In the user's locker window 10, the user is able to modify the contents of the locker and have increased interaction with the web page. In embodiments, the user is able to select one or more objects 12 from the web page and place them in the locker window 10 without any need to refresh or reload the web page. For example, languages such as XML, JavaScript, AJAX, etc. may allow content to be updated and/or altered in a web page without the need to refresh, or reload the rest of the page. In addition, HTML allows instructions written in these languages to be embedded with the text in the page itself.

The user may further have additional customizable options available in the locker window 10 such as: change the visibility object(s) 12 displayed in the locker, delete any of the object(s) 12, send the object(s) 12 to friends, etc. For example, the visibility of the object(s) 12 may be altered by changing the attributes e.g., between “visible” and “invisible” using various scripts such as visible.aspx, etc. What this means is that the user can view all object(s) 12 in his own locker, but if others view the locker, e.g., from their phones, a weblog, etc., they will only see the object(s) 12 that the user has marked as visible. For example, an icon such as an “open eye” may appear next to an object 12 dragged into the window 10 indicating that this object is visible to the public. The user may then restrict viewing of this object 12 to the public by clicking on the icon, causing its status to change to a “closed eye”, for example. As a result, the user is able customize their own locker as well as define what objects they want visible or invisible to the public.

FIGS. 6A-6C illustrate what the locker window 10 may look like on an actual browser display 14. As shown in FIGS. 6A-6C, the user may select various object(s) 12 on the display 14 and move them into the locker window 10 (e.g., by clicking, dragging, etc.). In these figures, the locker window 10 displays a screen with a message similar to the one as discussed with respect to FIG. 5A.

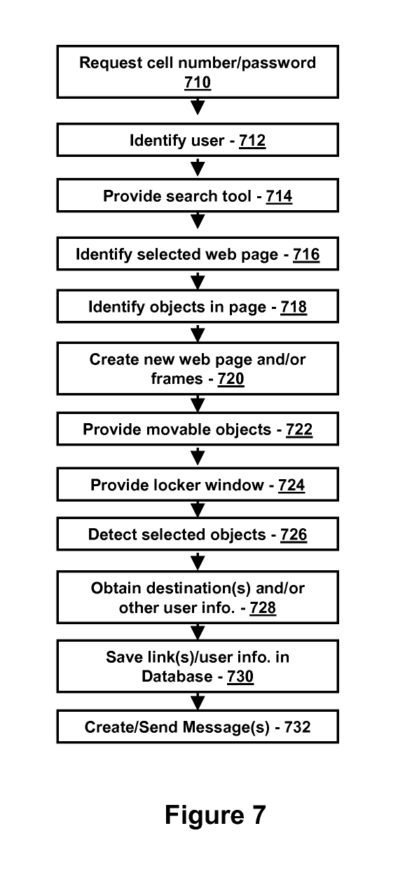

Method steps according to another aspect of the invention will now be described with respect to server processes as shown in FIG. 7. It is appreciated that the following steps need not be performed in the order listed, and that other steps may be performed in between. When a user visits the portal web site and e.g., desires to sign up for the services provided by the portal, he may be prompted by the server to register (if it is the first time), and/or provide his phone number, and optionally a password 710. The server application may then identify the user based on previously deposited cookies (or if the first time, deposit a cookie on the client device for identification of the user in the future) 712. In embodiments, the cookie may be a credential cookie based on the mobile phone number, etc. that is deposited on the client machine 102 so that the user will be automatically recognized the next time he visits the site. Such cookies may be used to automatically fill in form fields 52 for the user each subsequent visit so that the information only needs to entered once. Additionally, cookies may also be used for remembering third party e-mails from previous usages. These could take the form e.g., of an AJAX request such as: www.gabondo.com/get_friends.aspx?cell_no=17033895261. If this is the user's first time, cookies for third party addresses may be created using a server request such as: www.gabondo.com/send.aspx?type=image&src=http://website/images/imgl.jpg&country=Arizona&cell_no=17033895261&email1=my_friend1@hotmail.com@email2=my_friend2@google.com&message=I%20think%20you%20will%20like%20it!Check%20more%20on%20my%20Gabondo!

Additionally, a server script send.aspx may also be used to check to see if a user with that mobile phone number already has a locker on the server 104. If not, a locker may be created on the server 104 for that user. The user locker may contain information such as user's mobile phone number, country, SRCs of all the objects sent so far, source attributes (e.g., visible, non-visible), password, e-mail addresses of friends to which object(s) 12 have been sent so far, etc.

Once the user has been registered and/or authenticated, a conventional, or proprietary, search tool 714 for navigating the web, such as Google, Yahoo, etc., is provided through the portal. In embodiments, the search tool allows the user to browse in a typical fashion except that web pages selected by the user are identified by the portal 716. For example, various functions may be used to identify the web page such as “returnURl”, etc. In some embodiments, once the URI is identified, it is modified to redirect the user to a new page. For example, if the original web page is http://www.myspace.com, the location of the server 104 or portal may be inserted before the URI such that the user is directed to http://qmobile.com/index.aspx?link=http%3a%2f%2fwww.myspace.com. Objects 12 in the web page may further be identified 718 (e.g., by way of regular expressions). In addition, the locations of the identified objects 12 may be modified inserting/removing text from the beginning of the URIs (to create absolute positions), etc.

Regarding step 720, web page frame(s) may be modified or created. For example, in some embodiments, a new web page or frame may be concurrently displayed with the original web page, where the original page is rendered undetectable to the user. For example, the frame size of the original page may be reduced to only a few pixels, while the frame size of the new page is displayed on a full screen. In this way, it is possible that the URI in the browser bar may still reflect the original URI by maintaining a connection with the original page. In other embodiments, the original web page is displayed with the window 10 inserted into it and the object(s) 12 rendered movable. However, it is understood that the invention is not limited to the above described embodiments, and that other variations are possible.

According to step 722, object(s) 12 may be selected and moved to the locker window 10. Preferably, the page displayed to the user appears the same as the original page except that the locker window 10 is present and the user may now be able to freely select and move object(s) 12 on the page and drop them in the locker window 10 (which may at this point appear from minimized status) 724. In step 726, the object(s) put in the locker window 10 are identified and/or stored.

In embodiments, the application may include client-side scripts that identify and isolate the displayed object(s) 12, rendering them movable. For example, DOMs may be used to obtain a collection of multimedia object(s) 12 and listeners attached. These listeners may be activated each time the user moves or clicks the mouse over the object 12. A handler of the event may then go through the ancestors of the object that fired the event and sum all their relative positions, giving the absolute position. An object may then be positioned on that absolute position that gets the SRC the same as the one that fired the event, thus becoming its copy. (Alternatively, instead of positioning the object on an absolute position, the original object could be moved.) Then the copy is moved according to mouse moves. If the user releases the mouse button over the locker window 10, a JavaScript function may be called that turns on the form for sending the image, and at the same time the image is stored in an image container.

In addition, further client and/or server scripts, APIs, etc. include: getElementById; XMLHttpRequest; GetElementsByTagName (for XML manipulation and links manipulation); Cookies (for login information storing); CSS properties (to hide and move objects and change their representation); Replace function that handles regular expression in JavaScript (for link manipulation and processing user data); XML API (e.g., nodeValue, firstChild, etc., for manipulating with XML that is used as transportation layer for messages between client and server); InnerHTML (for fast changing of HTML objects); Events logic (for handling events, e.g., onmousemove, etc.). Additional scripts may include: Login.aspx for login; my_locker.aspx, delete.aspx, send_from_locker.aspx, visible.aspx, for the locker; etc.

Various delivery options 728 may be provided in the locker window 10. For example, the locker window 10 may provide the user with options to add contacts from their address books, such as Outlook Express, Mozilla Thunderbird, Yahoo mail, etc. (see FIG. 5H). In further embodiments, the object(s) 12 and corresponding links may be stored 730 to a database for future reference and/or targeted advertising. The database may use, for example, an MS SQL Server 2000. In addition, because most mobile devices 108 have different capabilities, an intelligent database may be used to further identify device 108 capabilities based upon brand and model, determined e.g., from the mobile number prefix. Once the user selects send at 732 an SMS, MMS, SMTP (e.g., e-mail), etc. message may be created and sent 732 that includes a link to the object(s) 12. In embodiments, the sending step invokes AJAX functionality that allows the data to be neatly packed together at the client and sent to the server, preferably wherein the web page does not need to be refreshed or reloaded. In this way, the contents of the locker window 10 may be easily managed and manipulated without disturbing the rest of the web page.

Upon depositing selected object(s) 12 in the locker window 10, the object(s) 12 may be stored to a database on the server 104. The database may perform various functions, such as checking the capabilities of the mobile device(s) 108, etc. In addition, since mobile devices 108 have limited storage capabilities, the object(s) 12 may be stored in the database as part of the services offered by the portal. In embodiments, a link may be created to the object(s) 12 and saved in the database for future reference, for purposes of targeted advertising, etc. An SMS, MMS, SMTP (e.g., e-mail) message, etc. may then be created including the link to the converted objects. In embodiments, if SMS messages are to be sent to the user's device and/or friends devices, the server may also make a database query based on mobile number prefixes. The database may contain a table of carriers which returns an e-mail domain that is used for “e-mail to SMS” transactions for that carrier. A server script may then be used to send an e-mail to 11234567890@tmomail.net, where tmomail.net is the result of the query. The e-mail may be used to send to the user's mobile phone 108 a link (e.g., as an email that arrives as a text message).

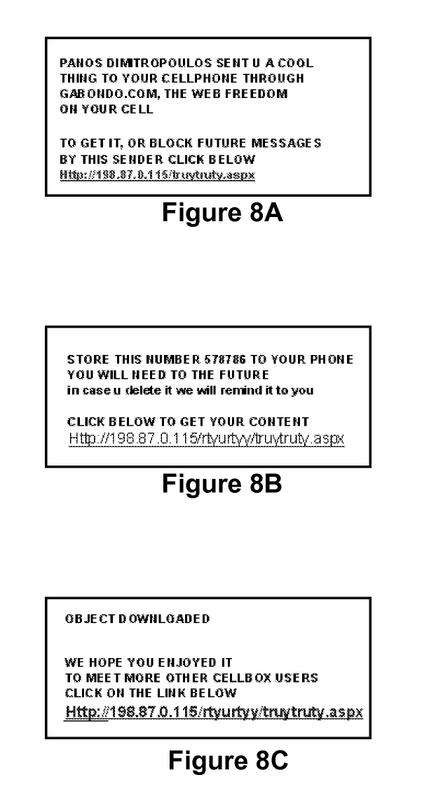

FIGS. 8A-8C illustrate message “screens” users may receive on their mobile devices 108. Typically, a user will receive an SMS, MMS, SMTP, message, etc. on his device 108 alerting him that the object(s) 12 are available as shown, for example, in FIG. 8A. This figure shows a message with a link, or URL, at the bottom of the message. Selecting the link may initiate the download process for the object(s) 12. Other options may also be presented to the user, such as the option to block future messages from the particular sender (in the case of spam, etc.). FIG. 8B additionally shows where a PIN may be received and stored on the device 108. FIG. 8C illustrates a message the user may receive once the download is complete. The user may also be presented with an opportunity to communicate with other users or to register with the portal themselves.

According to a further aspect, the invention discloses a method for performing business using a computer. The method may comprise performing the steps described above and further: obtaining one or more advertisements from one or more third parties related to the detected object(s); displaying the advertisements in the locker window 10; and charging one or more third parties a fee for displaying the advertisements. In embodiments, advertising information may also be obtained and displayed in the locker window 10 on the browser, on the mobile device 108, etc. In addition, advertising information may further be correlated with selected objects 12 for targeted display. Advertising information may be obtained by sending information about the user(s) and/or selected object(s). For example, information about users may be obtained from the mobile number itself (such as the prefix, extension, etc.), e.g., e-mail addresses the user has sent messages to, other contacts, search terms, or other user entered information. In addition, information about the selected object(s) may be obtained from the URI, the name of the object, the type of object, other information in the web pages such as keywords, meta-tags, etc. This information may be sent to a third party e.g., Google AdSense, or other vendors and relevant advertisements received in return. For example, if the object is a music file or ringtone (e.g., as identified by the file extension), this information may be sent to one or more third parties to obtain other music advertisements, etc. These advertisements may then be displayed in the locker window 10 in exchange for a fee or other arrangement.

The methods of the present invention may be implemented in software that can comprise a single file or a suite of files that can run independently or in an integrated fashion. The software may reside on different computers, but act in a concerted fashion to achieve the method steps described herein. In addition, the invention is not limited by the type of browser, but instead may be integrated or included with any suitable browser such as Internet Explorer, Mozilla, etc.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A method for allowing a user of a first device to select one or more objects to be communicated to one or more second devices and/or locations, said method comprising:
accessing content on a web page using a browser of the first device, wherein the content comprises one or more objects that are displayed on the first device;
selecting one or more objects to be communicated;
moving the object(s) into a customizable window displayed on the first device; and
performing one or more user events to initiate delivery of the object(s) to the one or more second devices and/or locations.

2. The method of claim 1, wherein at least one user event includes clicking a button provided in the customizable window.

3. The method of claim 1, wherein at least one user event includes entering personal text to be delivered with the object(s).

4. The method of claim 1, further comprising creating and sending one or more message(s) to the second device(s).

5. The method of claim 4, wherein at least one message is an SMS, MMS, or e-mail message containing a link that points to a location of the content.

6. The method of claim 4, wherein the one or more second device(s) include at least one of: mobile phone(s), personal digital assistant(s), pocket PC(s), and laptop(s).

7. The method of claim 1, wherein the one or more second location(s) include at least one of: a storage location on the client device, a storage location on a server, or a weblog.

8. The method of claim 1, wherein the content includes at least one of: images, graphics, audio files, video files, games, and text files.

9. The method of claim 8, wherein the audio files include music, ringtones, or both.

10. A method for providing a user of a first device to select one or more objects to be communicated to one or more second devices and/or locations, said method comprising:
allowing the user to access content on a web page using a browser of the first device, wherein the content comprises one or more objects that are displayed on the first device;
allowing the user to select one or more objects to be communicated;
providing a customizable window displayed on the first device;
allowing the user to move the selected object(s) into the customizable window; and
causing the selected object(s) to be communicated to the one or more second devices and/or locations.

11. The method of claim 10, wherein allowing the user to access content comprises providing a portal through which the user may access one or more web pages on the Internet.

12. The method of claim 11, wherein the portal is displayed on the first device as a pixel or another undetectable object.

13. The method of claim 10, wherein allowing the user to select one or more objects comprises rendering to the user through a portal a web page of interest in a manner wherein objects on the web page appear identical to the objects on the web page when rendered without passing through the portal, but wherein rendering of the objects through the portal allows them to be selected and moved regardless of whether they are movable in the web page as presented without passing through the portal.

14. The method of claim 10, wherein allowing the user to select one or more objects comprises identifying or tagging the object in a way that allows for communication of the object from one device to another.

15. The method of claim 10, wherein providing a customizable window displayed on the first device comprises using a portal to render an image on top of the web page, wherein the image is not present on the web page when not viewed through the portal.

16. The method of claim 10, wherein providing a customizable window displayed on the first device comprises providing one or more advertisements on the customizable window.

17. A method for allowing one or more objects in a web page displayed on a browser of a client device to be selected by a user of the client device and communicated to one or more second devices and/or locations, said method comprising:
identifying one or more objects displayed on the web page;
rendering the identified objects movable by the user through an input device;
providing a customizable window that is displayed in conjunction with the web page;
detecting one or more objects moved into the customizable window by the user;
detecting one or more user events; and
causing delivery of the detected object(s) to the one or more second devices and/or locations.

18. The method of claim 17, wherein the step of rendering the identified object(s) movable includes creating a copy of each object and attaching user-actuated listeners to each copy.

19. The method of claim 17, wherein at least one user-actuated event includes clicking a button in the customizable window.

20. The method of claim 17, wherein at least one user-actuated event includes entering the user's mobile phone number.

21. A method for performing business over a computer, said method comprising:
performing the method of claim 17;
displaying one or more advertisements in the customizable window; and
charging one or more third parties a fee for displaying the advertisements.

22. The method of claim 21, further comprising obtaining one or more advertisements by sending information about the user and/or detected object(s) to an advertising content provider.

23. The method of claim 21, wherein information about the user is obtained from the user's mobile phone number and/or e-mail contacts.

24. The method of claim 21, wherein information about the object(s) is obtained from a URI or filename associated with the object, or the type of object.

25. The method of claim 24, wherein the type of object may be selected from: images, graphics, music files, video files, games, ringtones and text files.
